(19) United States
(12) Patent Application Publication
(10) Pub. No.: US 2003/0017895 A1
(43) Pub. Date: Jan. 23, 2003

(54) Single turning rod belt tensioning bracket with improved engagement means and method for using same

(76) Inventor: Donald Baker, Ewing, NJ (US)

Correspondence Address: William L. Muckelroy, Esq., P.C., Ewing Professional Building, Suite 3A, 1901 N. Olden Avenue, Trenton, NJ, 08618, US

(21) Appl. No.: 09/908,679

(22) Filed: Jul. 20, 2001

(51) Int. Cl. F16H 7/14; F16H 7/22

(52) U.S. Cl. 474/114; 474/113; 474/122

(57) ABSTRACT

An improved belt tensioner for a refrigerant compressor mounted on a plate of a bus engine compartment, the compressor being operated by a power take off from the engine via a belt drive, the belt tensioner being flange mounted with a single plate attached to a single screw drive bolt, the plate being pushed against the compressor a predetermined and preset distance as determined by markers on a spring tension gauge mounted in between the single plate and the flange wherein the flange is fixed to the plate.

### BACKGROUND OF THE INVENTION

1. Field of the Invention

The present invention relates to a belt tensioner for use on a belt which is spanned between a power take off from the transmission of an internal combustion engine and its air conditioning compressor, and more particularly to a belt tensioner which can obtain an optimum tension force applied on the belt using a single adjusting rod coupled to a pivoting engaging member.

2. Description of the Prior Art

In the prior art, an internal combustion engine for a mass transport motor vehicle such as a bus generally has a crank pulley, an alternator, an air conditioning compressor, and a V-belt spanned between the crank pulley, the compressor, and the alternator. The rotation of the crank pulley is transmitted through the V-belt to the compressor. If the tension force applied onto the V-belt is greater than an adequate value, this impairs the endurance of bearings employed for the compressor. Conversely, if the tension force applied onto the V-belt is less than the adequate value, this causes a slippage of the V-belt and further a decrease in the cooling effected by the compressor and in an amount of an electric power generated by the alternator.

In general, a tension force applied onto the V-belt is adjusted by a procedure whereby a set of push rods attached to push blocks resting against the compressor are individually moved backwards or forwards to adjust the position of the compressor after bolts mounting the compressor onto a mounting plate attached to the engine are sufficiently loosened. After adjustment the tension of the belt is checked with a tension gauge and further adjusted as necessary to obtain the desired tension on the belt driving the compressor.

Thus, in the prior art arrangement at least two push blocks and associated rods are used for tension adjustment. A worker sets an optimum tension force while another worker measures the amount of a tension force applied on the V-belt or other belt. However, with the two push rods it is difficult to easily set an optimum belt tension force. The use of two mechanics is labor intensive and expensive. Moreover, the use of two push rods sometimes unnecessarily results in skewing of the compressor pulley out of the plane of motion of the belt.

By way of background, in 1930 Thompson received U.S. Pat. No. 1,783,987 for a chain adjusting device. The device automatically takes up slack in an auto drive chain when it becomes objectionably tight by using a spring loaded sprocket pressing against the chain.

In 1957 Gehre was issued U.S. Pat. No. 2,806,382 for a belt tensioning device. This device maintains a predetermined tension of a belt in driving relation with a pulley attached to an automobile engine by using a compressed spring in a manner similar to that used by Thompson for a chain and provides an indicator means comprising an indicator needle for ascertaining by visual inspection the degree of belt stretching resulting from prolonged service.

In 1961 Murray was issued U.S. Pat. No. 2,985,027 for a slack adjuster or device for adjusting the slack in a chain or belt drive. This device operates by expressing force directly against the chain or belt at a point in between the drive pulley and the driven pulley.

In 1974 Pfarrwaller was issued U.S. Pat. No. 3,817,113 for a chain drive with an idler wheel tensioning means biased by elongated pads. Pfarrwaller improves the tensioned adjusted chain drive wherein the tension is abruptly adjusted by a third member acting against the chain by using resilient material to support the third member, and the resilient material acts as a shock absorber and allows the third member to be deflected.

Murray is similar in operation and structure to U.S. Pat. No. 4,509,934 which issued on Apr. 9, 1985 to Ballius for an external transfer case chain slack adjustment structure. Ballius employs a roller which inwardly deflects a chain and is rollingly engaged with slack reach of the chain.

In 1986 Kawasawa et al. was issued U.S. Pat. No. 4,583,961 for a V-belt tensioner which is spanned between the driving member and a driven member. A rotatable adjustment bolt moves a bracket which slidably supports a slider secure to the driven member. The adjustment bolt is spring biased to fix its position.

On Jul. 9, 1991 Bryant was issued U.S. Pat. No. 5,030,173 for a spring loaded telescopic tube take-up. The device is a belt take-up for a conveyor wherein the belt take-up is provided with an internal compression spring to adjustably bias the bearing support tube to control tension on a conveyor belt. A scale which indicates tension is further disclosed and used with a load circuit to stop the conveyor at extremely high or low tension readouts.

On Mar. 19, 1996 Tsai et al. was issued U.S. Pat. No. 5,499,950 for a belt tensioner and actuator. The belt tensioner and the actuator of the tensioner employs classic third party transverse forced applied to the belt. The assembly has a rotatable shaft that is operatively interconnected to a spring and is provided with opposite ends one of which is operatively interconnected to a piston.

### OBJECTS OF THE INVENTION

It is accordingly a primary object of this invention to provide a belt tensioner for a bus vehicle compartment and platform which provides a single vector force orthogonal to compressor surface which is in turn orthogonal to the plane or rotation of a pulley and belt assembly by adjusting single push rod.

It is an object of the present invention to provide a combination of a demountable bracket and a belt tensioner actuated by a single rod connected to an engaging member adapted for engaging a compressor wall which is pivotingly attached to a force delivering end of the rod.

It is an object of the present invention to provide a combination of a demountable bracket, a belt tensioner actuated by a single rod connected to a single engaging member for engaging a compressor which is pivotingly attached to a force delivering end of the rod.

It is an object of the invention to provide an improvement in a method for adjusting the tension of a belt drive for a refrigerant compressor by eliminating steps requiring the adjustment of parallel force vectors to adjust the tension of the compressor belt.

To attain the above objects, a belt tensioner according to the present invention, adjusts a belt tension force of a belt for transmitting a torque of a driving member which is mounted on a main body to a driven member which is rotatably mounted on the main body. The belt tensioner has a novel adjust means, a bracket secured to the main body, and a slider secured onto the driven member at one end thereof The adjusting means includes a head portion, a first shaft portion which has a thread-engaging relationship with a threaded hole provided in the bracket, and a second shaft portion which slidably supports the slider. The adjust means is constantly biased by the biasing means which is provided between the head portion and the bracket. When the adjust means rotates to obtain an optimum belt tension force, the slider approaches the first shaft portion according to the rotation of the adjust means. Further, the adjust means rotates, thereby reacting to the condition that the first shaft portion fits into the hole within the bracket. Finally, when the head portion comes in contact with the bracket, the optimum belt tension force is obtained.

### SUMMARY OF THE INVENTION

The novel structure and method embodying the teachings of the present invention enables more efficient adjustment of the belt tension for a refrigerant compressor of a bus wherein the compressor is mounted on a platform connected to the transmission and wherein the compressor is belt driven from a power take-off connected to the transmission. The novel improvement comprises the structural combination of a built-in gauge pre-marked for range of adjustments for new and used belts and a single threaded rod extending through a threaded aperture and movable in a turn screw fashion against a side of the compressor via a pivoting engaging plate or cup, the plate or cup being made of high tensile strength steel capable of receiving at least several multiples of 240 pounds per square inch of pressure at any single point of engagement of the rod with the pivoting base of the plate or cup. The novel method is a significant improvement over the prior art method by eliminating the prior art structure and steps of having to adjust a plurality of rods, namely two side by side parallel rods, both separately and independently engaging the compressor with a non-swiveling engagement contact protrusion. In the prior art, each of the plurality of rods engages the compressor without the advantage or benefit of a built-in gauge pre-marked for range of adjustments for new and used belts. The two rods when independently adjusted tend to unevenly adjust or catercorner the compressor position on the mounting plate in relationship to the plane of the compressor belt. Whereas, the novel improved structure comprising one rod and an engaging swivelable faceplate juxtaposed against an orthogonal wall or surface of the compressor substantially diminishes catercornering. In the novel adjustment method, the inherent elasticity of the belt and compressor assembly is utilized to press a face of the compressor evenly against the swiveling faceplate, thereby evenly distributing the tension from the belt against the faceplate.

### BRIEF DESCRIPTION OF THE DRAWINGS

These and other features, aspects, and advantages of the present invention will become better understood with regard to the following description, appended claims, and accompanying drawings wherein:

FIG. 1 is a detailed perspective view showing the prior art assembly and method for adjusting the tension of a belt connected to a compressor by moving the compressor.

FIG. 2 is a detailed perspective view showing the novel and improved assembly and novel method for adjusting the tension of a belt connected to a compressor by moving the compressor.

FIG. 3 is a detailed top view of the novel improved push block assembly for adjusting the tension of a belt connected to a compressor in a bus.

FIG. 4 is a detailed rear view of the novel improved push block assembly.

FIG. 5 is a detailed bottom view of the novel improved push block assembly.

FIG. 6 is a front view of the novel improved push block assembly.

FIG. 7 is a perspective view of the novel improved push block assembly showing details of the presets on a tension gauge pin assembly.

### DESCRIPTION OF THE PREFERRED EMBODIMENT

The present invention will be described hereinafter with reference to the accompanying drawings which illustrate a preferred embodiment of the invention.

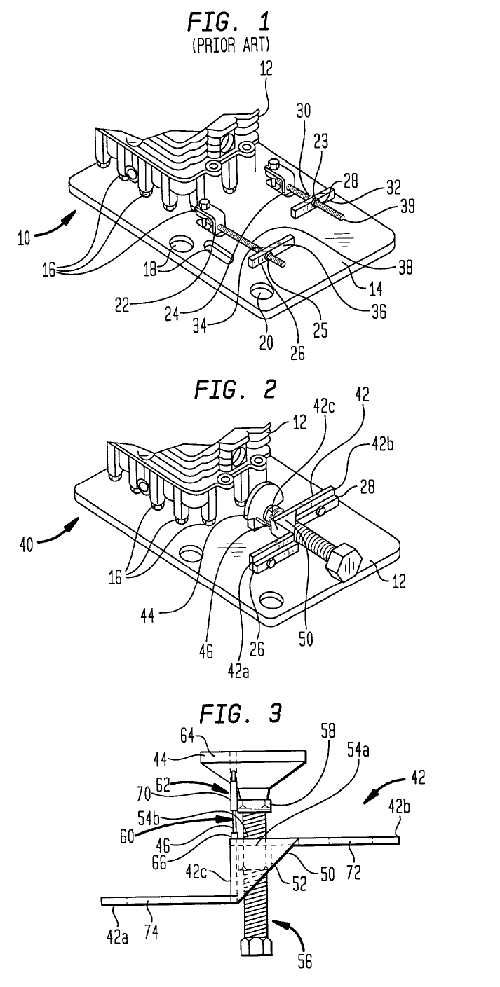

Shown in FIG. 1 is an example of the prior art. This invention as illustrated in the remaining figures presents several novel improvements over the prior art including eliminating a push rod, using a swivelable flat push block and bracket assembly that, during tension adjustments, uses the elasticity of the tensioned belt to force the block flat against the compressor, and using preset markings on a gauge to set the compressor for new and/or used belts.

There in FIG. 1 is shown an assembly 10 of a bus refrigerant or air conditioning compressor 12 mounted on a plate 14 via a plurality of mount bolt and nut sets 16. The plate 14 is fashioned with a plurality of strategically placed apertures 18 and 20 to facilitate attachment of other items to the plate 14 and vice versa. In the prior art a pair of push members 22 and 24 are used to push the compressor 12 away from the push members 22 and 24 by adjusting one push member forward toward the compressor 12 first, for example member 22, and then by adjusting the other push member forward toward the compressor 12 next, for example member 24.

The compressor 12 is powered by a pulley (not shown) connected via a belt (not shown) connected to a pulley of a power take off or PTO (not shown) of a bus transmission (not shown). The purpose of the push members 22 and 24 is to adjust the tension on the belt connecting the PTO to the compressor 12 by pushing the compressor 12 away from the PTO.

As shown for the prior art in FIG. 1, the push member 22 is mounted in a hole 23 in a mounting block 26 which vertically extends from the plate 14. The push member 24 is mounted in a hole 25 in a mounting block 28 which vertically extends from the plate 14, parallel to the mounting block 26. The push members 22 and 24 are fixedly attached in the holes 23 and 25, respectively, by means of nuts 30, 32, 34, and 36 threadedly mounted on the respective push members 22 and 24 on each vertical face of each of the mounting blocks 26 and 28, respectively.

The push members 22 and 24 are made of threaded cylindrical rods 38 and 39, respectively. In the cumbersome prior art arrangement, the rod 38 is mounted in the hole 25 with nuts 34 and 36, which are screwed onto the rod 38. Likewise, the rod 39 is mounted in the hole 23 with nuts 30 and 32, which are screwed onto the rod 39.

An improved novel assembly 40 is shown in FIG. 2. The assembly 40 is improved by eliminating one of the push rods and thereby eliminating the steps of having to adjust two separate rods back and forth to achieve an even as compared to a cantered push on the compressor 12. In the novel assembly 40 there is shown a push plate 44 connected to a marker device 46. The marker device 46 is connected to a flange 42. The flange 42 is made of two thick long parallel rectangular steel plates 42a and 42b spaced apart and interconnected by an orthogonal plate 42c. A relatively smaller bracing plate 50 is shown connected to adjoining top edges of the plates 42a, 42b, and 42c.

Shown in FIG. 3 is a nut 52 permanently and immovably attached to the plates 42b and 42c. The nut 52 has an aperture 54a aligned with another aperture 54b formed in the plate 42b. A bolt 56 threadedly extends through the nut 52 and connects to a push plate 44. The push plate 44 is pushed by the bolt 56 against the compressor 12 and thereby adjusts the tension of a belt (not shown) connected to the compressor 12. The push plate 44 is connected to the bolt 56 via nut and swivel assembly 58.

The push plate 44, selected to several times larger (e.g. six times) in surface area than the cross-sectional area of the bolt 56, houses a tension gauge 46 made of a rod or pin 60 with preset markings for specific tensions thereon. One end of the pin 60 extends into a cylinder 62 and is non-frictionally and slidably engaged in a horizontal aperture 64 located in the push plate 44. Another end of the pin 60 extends into a cylindrical roll rod 66 set horizontally in the plate 42c. The horizontal aperture 64 non-frictionally allows the pin 60 to slide or move in and out as tension on compressor 12 from the belt (not shown) is adjusted.

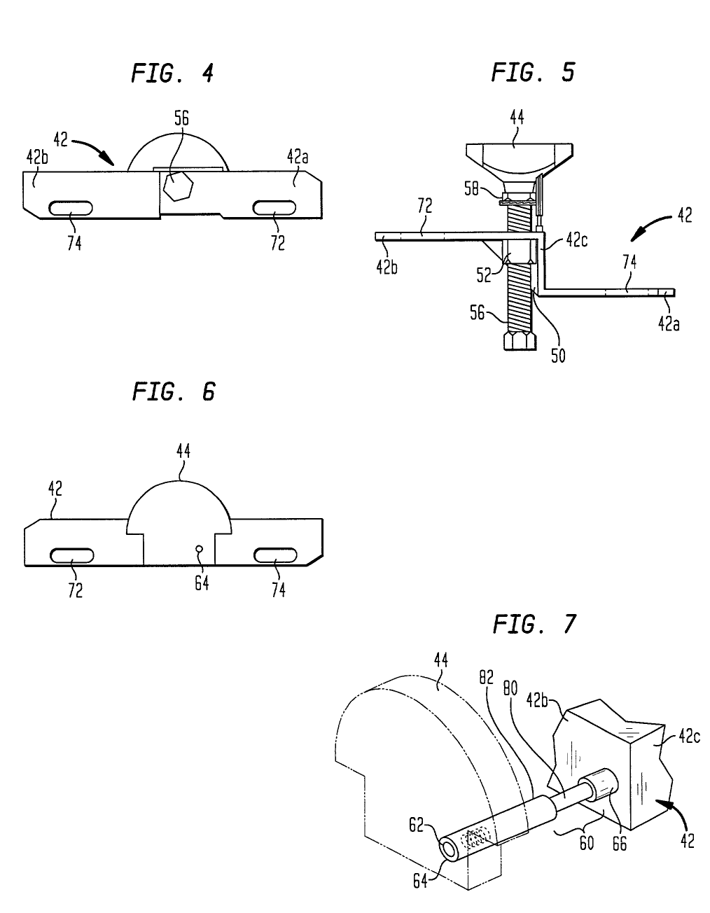

Referring to FIG. 4, there the flange 42 made of the plate 42b is shown with apertures 72 therein for mounting onto the mounting block 28 (shown in FIG. 1). The plate 42a has apertures 74 for mounting onto the mounting block 26 (shown in FIG. 1). A bottom view of the flange 42 and push plate 44 as assembled is illustrated in FIG. 5. And in FIGS. 6 and 7 there is shown a frontal view of the flange 42 and push plate 44 with the aperture 64 for the pin 60. The pin 60 functions as a tension gauge. The pin 60 is adapted with a plurality of preset markings 80 and 82, for example, to indicate positions of the push block 44 corresponding to appropriate tensioning positions for belts (not shown): for example, belts A and B wherein belt B is a new belt first placed in service and belt B is a used belt in services for 600 hours.

As this invention may be embodied in several forms and utilize each of many kinds of engaging cups or plates with any single rod or quantity adjustable vector force delivery system without departing from the spirit or essential characteristics thereof, the present embodiment is, therefore, illustrative and not restrictive, since the scope of the invention is defined by the appended claims rather than by the description preceding them, and all changes that fall within the metes and bounds of the claims or that form their functional as well as conjointly cooperative equivalent steps are, therefore, intended to be embraced by those claims.

### PARTS LIST

10 assembly

12 air conditioning compressor

14 plate

16 plurality of mount bolt and nut sets

18 first aperture

20 second aperture

22 first push member

24 second push member

23 hole

26 first mounting block

25 second hole

28 second mounting block

30 first nut

32 second nut

34 third nut

36 fourth nut

38 first cylindrical rod

39 second cylindrical rod

40 improved novel assembly

42 flange

42a rectangular steel plate

42b rectangular steel plate

42c orthogonal plate

44 singular push plate

46 tension gauge

50 bracing plate

52 fixed nut

54a aperture

54b aperture

56 bolt

58 nut and swivel assembly

60 pin

62 cylinder

64 horizontal aperture

66 cylindrical roll rod

72 first apertures

74 second apertures

80 preset marking

82 preset marking

What is claimed is:

1. In a motor vehicle having a slide mounted refrigerant compressor, mounted by a mounting means, belt driven from a power take-off on a side of a transmission wherein the compressor is mounted on a platform attached to the transmission, the platform having a means for adjusting the tension in the belt, the improvement comprising a demountably attached bracket on the platform, the bracket having an improved adjustment means for adjusting the tension in the belt, the improved adjustment means comprising a single threaded rod engaging a nut mounted on the bracket.

2. In a motor vehicle having a slide mounted refrigerant compressor, mounted by a mounting means for connecting the compressor to the motor vehicle, the compressor being belt driven from a power take-off on a side of a transmission, and wherein the compressor is mounted on a platform attached to the transmission, the platform having a means for adjusting the tension in the belt, the improvement comprising a bracket demountably attached to the platform, the bracket having an improved adjustment means for adjusting the tension in the belt, the improved adjustment means comprising a single threaded rod threadedly engaging a nut mounted on the bracket, the rod and nut forming an assembly for applying force to a member engaging a wall of the compressor whereby pressure is applied to the belt by turning the rod in a first circular direction and pressure is relieved from the belt by turning the rod in an opposite circular direction, the mounting means for the compressor being unengaged.

3. In a motor vehicle having a slide mounted refrigerant compressor, mounted by a mounting means for connecting the compressor to the motor vehicle, the compressor being belt driven from a power take-off on a face of a transmission, and wherein the compressor is mounted on a platform attached to the transmission, the platform having at least two parallel rod means for adjusting the tension in the belt by moving the compressor, and the method of adjusting the tension in the belt comprising a first step of adjusting one of the parallel rod means and a second step of adjusting another of the parallel rod means, the improvement comprising a bracket demountably attached to the platform, the bracket having a single rod adjustment means for adjusting the tension in the belt, the improved adjustment method comprising the step of adjusting the single rod adjustment means, the single rod adjustment means having a swivelable plate attached to the rod, the improved method comprising the step of positioning the swivelable plate adjacent to the compressor and applying force to a member engaging a wall of the compressor whereby pressure is applied to the belt by turning the rod in a first circular direction and pressure is relieved from the belt by turning the rod in an opposite circular direction, the mounting means for the compressor being unengaged.

4. The improved method of claim 3 further comprising demountably attaching the single rod adjustment means to the bracket.

5. The structure according to claim 2 wherein the compressor is demountably attached to a mounting plate connected to the motor vehicle.

6. The structure according to claim 1 wherein the rod and nut forms an assembly for applying force to a member engaging a wall of the compressor.

7. The structure according to claim 1 wherein the rod is threaded whereby pressure is applied to the belt by turning the rod in a first circular direction and pressure is relieved from the belt by turning the rod in an opposite or second circular direction.

8. The structure according to claim 1 wherein the mounting means for the compressor is selectively unengaged when force is being applied to the compressor by the rod and nut assembly.
